(19) United States
(12) Patent Application Publication
(10) Pub. No.: US 2025/0385377 A1
(43) Pub. Date: Dec. 18, 2025

(54) POWER STORAGE DEVICE

(71) Applicant: TOYOTA JIDOSHA KABUSHIKI KAISHA, Toyota-shi (JP)

(72) Inventors: Shigeyuki INOUE, Toyota-shi (JP); Kazuki Sugie, Miyoshi-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 19/223,458

(22) Filed: May 30, 2025

(30) Foreign Application Priority Data
Jun. 13, 2024 (JP) 2024-096042

(51) Int. Cl. H01M 50/291; B60L 50/60; H01M 50/209; H01M 50/548

(52) U.S. Cl. CPC H01M 50/291; H01M 50/209; H01M 50/548; B60L 50/66; H01M 2220/20

(57) ABSTRACT

A power storage device includes: a first power storage stack including a plurality of power storage cells; a second power storage stack including a plurality of power storage cells; and a partition wall separating the first and second power storage stacks from each other. The power storage cells each include a cell main body and an external terminal. The partition wall includes: an upper partition portion located at a higher position than the external terminal; a lower partition portion located at a lower position than the external terminal; and a connecting portion located between a pair of the external terminals adjacent to each other in the second direction, and connecting the upper and lower partition portions to each other. A width of the connecting portion is smaller than a width of the upper partition portion and a width of the lower partition portion.

This nonprovisional application is based on Japanese Patent Application No. 2024-096042 filed on Jun. 13, 2024 with the Japan Patent Office, the entire contents of which are hereby incorporated by reference.

### BACKGROUND

### Field

The present disclosure relates to a power storage device.

### Description of the Background Art

For example, Japanese National Patent Publication No. 2022-525014 discloses a power battery pack including a plurality of unit cells and a housing device. An external terminal and an explosion-proof valve are provided on a side surface of the case of each unit cell.

### SUMMARY

In the power storage device described in Japanese National Patent Publication No. 2022-525014, improvement in volumetric efficiency is desired.

An object of the present disclosure is to provide a power storage device enabling improvement in volumetric efficiency.

A power storage device according to one aspect of the present disclosure includes: a first power storage stack including a plurality of power storage cells arranged in a first direction; a second power storage stack facing the first power storage stack in a second direction orthogonal to both the first direction and an upward-downward direction, the second power storage stack including a plurality of power storage cells arranged in the first direction; and a partition wall separating the first power storage stack and the second power storage stack from each other, the power storage cells each include: a cell main body; and an external terminal protruding from the cell main body in the second direction, the partition wall includes: an upper partition portion located at a higher position than the external terminal; a lower partition portion located at a lower position than the external terminal; and a connecting portion located between a pair of the external terminals adjacent to each other in the second direction, the connecting portion connecting the upper partition portion and the lower partition portion to each other, and a width of the connecting portion in the second direction is smaller than a width of the upper partition portion in the second direction and a width of the lower partition portion in the second direction.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically illustrating a vehicle including a power storage device according to an embodiment of the present disclosure.

FIG. 2 is a perspective view schematically showing a power storage device and a frame member.

FIG. 3 is a cross-sectional view taken along line III-III in FIG. 2.

FIG. 4 is a cross-sectional view taken along line IV-IV in FIG. 3.

FIG. 5 is an exploded cross-sectional view of the power storage device.

FIG. 6 is a plan view schematically showing a frame body and a partition wall.

FIG. 7 is a cross-sectional view schematically showing the vicinity of a partition wall.

### DESCRIPTION OF THE PREFERRED EMBODIMENTS

Embodiments of the present disclosure will be described with reference to the drawings. In the drawings referred to below, the same or corresponding members are denoted by the same reference numerals.

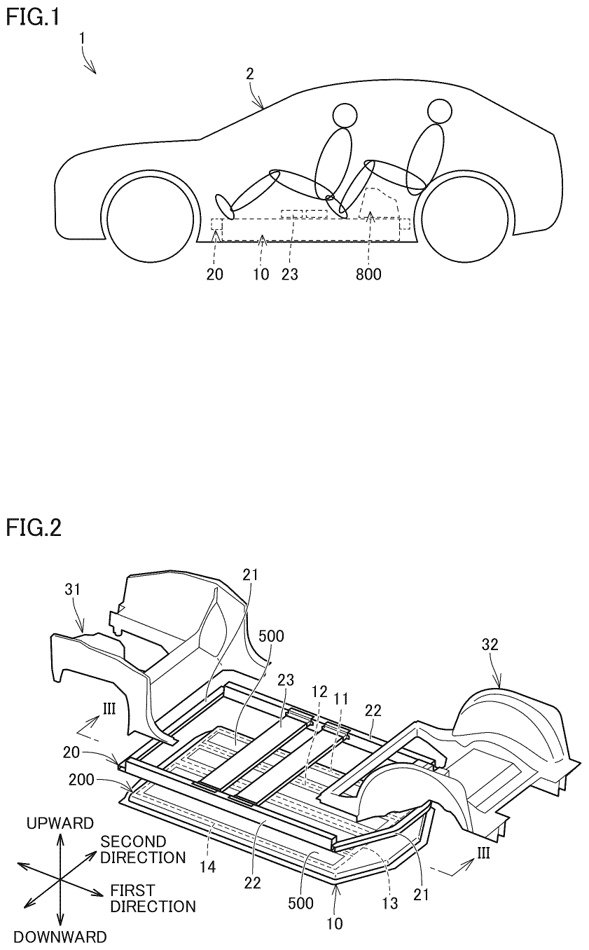

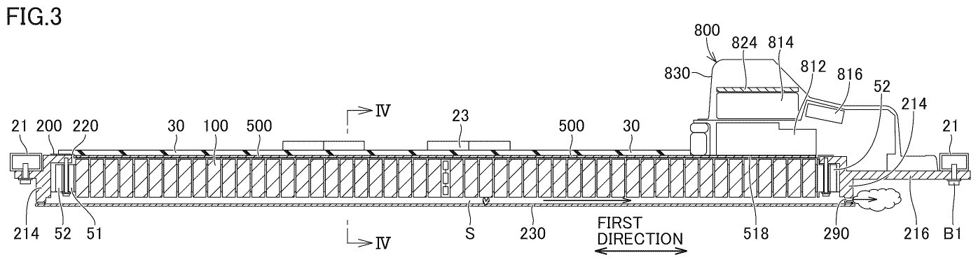

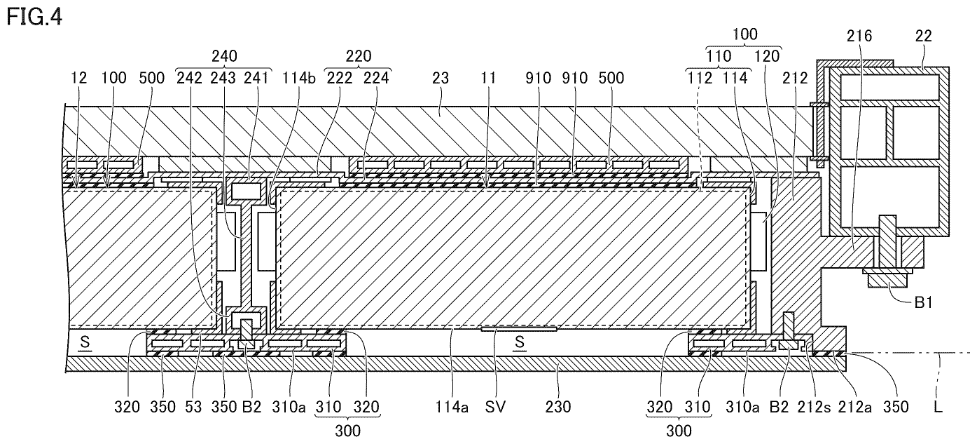

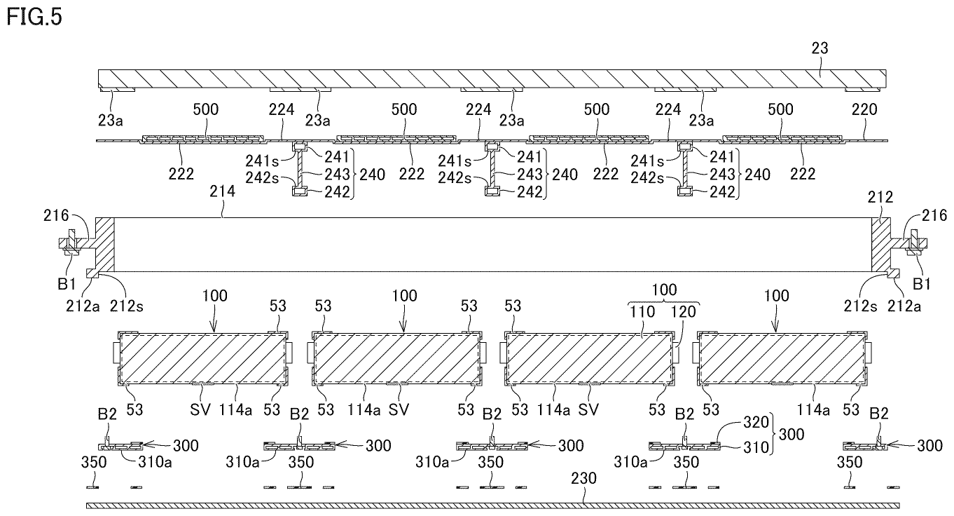

FIG. 1 is a diagram schematically illustrating a vehicle including a power storage device according to an embodiment of the present disclosure. FIG. 2 is a perspective view schematically showing a power storage device and a frame member. FIG. 3 is a cross-sectional view taken along line III-III in FIG. 2. FIG. 4 is a cross-sectional view taken along line IV-IV in FIG. 3. FIG. 5 is an exploded cross-sectional view of the power storage device.

As illustrated in FIG. 1, the vehicle 1 includes a vehicle main body 2 and a power storage device 10. Examples of the vehicle 1 include a hybrid electric vehicle, a plug-in hybrid electric vehicle, and a battery electric vehicle.

As shown in FIGS. 1 and 2, the vehicle main body 2 includes a frame member 20, a front constituent member 31, and a rear constituent member 32. The frame member 20 is disposed at a bottom portion of the vehicle main body 2. The frame member 20 includes a pair of first frames 21, a pair of second frames 22, and a cross frame 23.

The pair of first frames 21 face each other in the first direction. The first direction may be a direction parallel to the front-rear direction of the vehicle 1. In the example shown in FIG. 2, the first frame 21 disposed on the front side has a shape extending in a second direction orthogonal to both the first direction and the upward-downward direction. The first frame 21 disposed rearward has a shape that extends in the second direction and is convex rearward. The second direction may be a direction parallel to the left-right direction (width direction) of the vehicle 1.

The pair of second frames 22 face each other in the second direction. Each second frame 22 has a shape extending in the first direction. An end portion of each second frame 22 in the first direction is connected to the first frame 21. The pair of second frames 22 and the pair of first frames 21 are formed in a substantially quadrangular cylindrical shape surrounding the power storage device 10.

The cross frame 23 is disposed between the pair of first frames 21 and connects the pair of second frames 22 to each other. The cross frame 23 constitutes, for example, a seat cloth. A spacer 23a is disposed on the lower surface of the cross frame 23.

The front constituent member 31 is connected to the front portion of the frame member 20. The rear constituent member 32 is connected to the rear portion of the frame member 20. Each of the constituent members 31 and 32 may be formed by aluminum die casting.

The power storage device 10 is attached to the frame member 20. As shown in FIGS. 2 to 6, the power storage device 10 is disposed below the cross frame 23. As illustrated in FIGS. 1 to 6, the power storage device 10 includes four power storage stacks 11 to 14, a housing 200, a support member 300, a cooler 500, and a device unit 800. The number of power storage stacks is not limited to four. In FIG. 2, the device unit 800 is not illustrated.

Each of the power storage stacks 11 to 14 includes at least one power storage cell 100. In the present embodiment, each of the power storage stacks 11 to 14 includes a power storage cell group including a plurality of (for example, 50) power storage cells 100 arranged in the first direction. Each of the power storage stacks 11 to 14 may further include a plurality of spacers. Each spacer is disposed between a pair of power storage cells 100 adjacent to each other in the power storage cell group. Each of the power storage stacks 11 to 14 is formed in a rectangular parallelepiped shape elongated in the first direction. As shown in FIG. 2, the four power storage stacks 11 to 14 are arranged side by side in the second direction.

As shown in FIG. 3, a pair of end plates 51 that sandwich the plurality of power storage cells 100 from both sides in the first direction are provided on both sides of the plurality of power storage cells 100 in the first direction. A monitoring unit (Smart Battery Management) 52 is disposed outside each end plate 51 in the first direction. As shown in FIGS. 4, 5 and 7, a restraint band 53 is connected to the pair of end plates 51. The restraint band 53 restrains the power storage stacks 11 to 14 from both sides in the first direction.

As shown in FIGS. 4 to 6, each power storage cell 100 has a cell main body 110 and a pair of external terminals 120. FIG. 4 illustrates the power storage cell 100 included in the first power storage stack 11 and a part of the power storage cell 100 included in the second power storage stack 12.

The cell main body 110 includes an electrode assembly 112 and a cell case 114. The thickness direction of the cell main body 110 corresponds to the first direction. The width direction (direction perpendicular to both the thickness direction and the upward-downward direction) of the cell main body 110 corresponds to the second direction.

The electrode assembly 112 may be configured by a wound body in which a positive electrode sheet and a negative electrode sheet are wound with a separator interposed therebetween, or may be configured by a stack in which a positive electrode sheet and a negative electrode sheet are stacked with a separator interposed therebetween. The electrode assembly 112 is formed in a shape elongated in the second direction.

The cell case 114 accommodates the electrode assembly 112. The cell case 114 is formed in a rectangular parallelepiped shape. The cell case 114 is made of metal such as aluminum.

As shown in FIGS. 4 and 5, a safety valve SV is provided on the lower surface 114a of the cell case 114.

Each external terminal 120 protrudes in the second direction from the side surface 114b of the cell case 114 in the second direction. One of the pair of external terminals 120 protrudes from the side surface 114b of the cell case 114 to one side in the second direction. The other of the pair of external terminals 120 protrudes from the side surface 114b of the cell case 114 to the other side in the second direction.

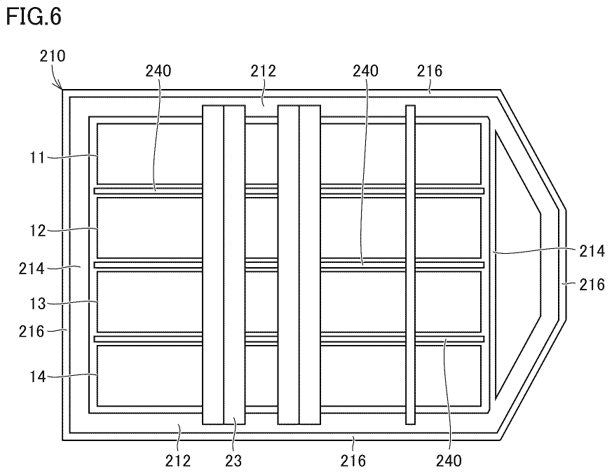

The housing 200 accommodates four power storage stacks 11 to 14. As illustrated in FIGS. 4 to 6, the housing 200 includes a frame body 210, a top wall 220, a bottom wall 230, and a plurality of (three in the present embodiment) partition walls 240. In FIG. 6, the top wall 220 is not shown.

The frame body 210 collectively surrounds the four power storage stacks 11 to 14. The frame body 210 may be formed in a quadrangular cylindrical shape. The frame body 210 is formed by, for example, aluminum die casting. As illustrated in FIGS. 3 to 6, the frame body 210 includes a pair of side walls 212, a pair of connecting walls 214, and a fixing portion 216.

As shown in FIGS. 4 to 6, each side wall 212 is disposed outside the plurality of power storage stacks in the second direction. That is, the pair of side walls 212 are disposed at positions sandwiching the four power storage stacks 11 to 14 in the second direction. Each side wall 212 extends in the first direction. The length of each of the side walls 212 in the first direction is longer than the length of each of the power storage stacks 11 to 14 in the first direction.

The pair of connecting walls 214 are provided on both sides of at least one power storage cell 100 in the first direction (thickness direction). Each connecting wall 214 connects the pair of side walls 212. In the present embodiment, the connecting wall 214 disposed on one side in the first direction (front side in the front-rear direction of the vehicle) connects one end portions (front end portions) of the side walls 212 in the first direction. The connecting wall 214 disposed on the other side in the first direction (rear side in the front-rear direction of the vehicle) connects the other end portions (rear end portions) of the side walls 212 in the first direction.

The fixing portion 216 is a portion connected to the frame member 20. The fixing portion 216 has a shape protruding outward from the outer surface of the first frame 21 and the outer surface of the second frame 22. The fixing portion 216 is fastened to the frames 21 and 22 from below by bolts B1.

The top wall 220 is provided above the at least one power storage cell 100. In the present embodiment, the top wall 220 is provided above the four power storage stacks 11 to 14. The top wall 220 covers the four power storage stacks 11 to 14. The top wall 220 is connected to an upper end portion of the frame body 210. Specifically, the top wall 220 is connected to the upper end portion of each side wall 212 and the upper end portion of each connecting wall 214 by welding or the like. As shown in FIGS. 4 and 5, the top wall 220 has a top portion 222 and four recesses 224.

The top portion 222 is formed flat. The top portion 222 overlaps the end portion of each power storage stack in the second direction in the upward-downward direction. A spacer 23a is provided between the top portion 222 and the cross frame 23.

Each recess 224 is recessed downward from the top portion 222. Each recess 224 is formed flat. Each recess 224 is formed above the central portion of each of the power storage stacks 11 to 14 in the second direction. As illustrated in FIG. 4, the length of each recess 224 in the second direction is shorter than the length of the power storage cell 100 in the second direction. Each recess 224 is in contact with the upper surface of the cell case 114 via the thermally conductive adhesive 910.

The bottom wall 230 is disposed below the at least one power storage cell 100. In the present embodiment, the bottom wall 230 is disposed below the four power storage stacks 11 to 14. The bottom wall 230 is connected to a lower portion of the frame body 210. More specifically, the bottom wall 230 is connected to a lower end portion of each of the side walls 212 and a lower end portion of each of the connecting walls 214 by an adhesive member 350 (see FIGS. 4 and 5). In addition, the bottom wall 230 may be fastened to a lower portion of the frame body 210 by a bolt. The bottom wall 230 is preferably formed in a flat plate shape.

The partition walls 240 partition a pair of power storage stacks facing each other in the second direction. Each partition wall 240 is disposed between a pair of external terminals 120 facing each other in the second direction. Each partition wall 240 extends in the first direction. An end portion of each partition wall 240 in the first direction may be connected to the connecting wall 214 of the frame body 210 or may be separated from the connecting wall 214. Each partition wall 240 extends downward from the top wall 220. Each partition wall 240 is connected to the cross frame 23 via the top wall 220 and the spacer 23a. Each partition wall 240 may be formed by extrusion of a metal such as aluminum.

As illustrated in FIGS. 4, 5, and 7, each partition wall 240 includes an upper partition portion 241, a lower partition portion 242, and a connecting portion 243.

The upper partition portion 241 is provided at a position higher than the external terminal 120. The upper partition portion 241 is connected to the top wall 220. Specifically, the upper surface of the upper partition portion 241 is connected to the lower surface of the top portion 222 of the top wall 220 by welding, bonding, fastening, or the like. The upper partition portion 241 may be formed in a hollow shape. In the present embodiment, the upper partition portion 241 is formed in a quadrangular cylindrical shape extending in the first direction. The upper partition portion 241 is disposed between a pair of restraint bands 53 adjacent to each other in the second direction.

The lower partition portion 242 is provided at a position lower than the external terminal 120. The lower partition portion 242 may be formed in a hollow shape. In the present embodiment, the lower partition portion 242 is formed in a quadrangular cylindrical shape extending in the first direction. The lower partition portion 242 is disposed between a pair of restraint bands 53 adjacent to each other in the second direction.

The connecting portion 243 connects the upper partition portion 241 and the lower partition portion 242. The connecting portion 243 is provided between a pair of external terminals 120 adjacent to each other in the second direction. The connecting portion 243 is formed in a flat plate shape. The width of the connecting portion 243 in the second direction is smaller than the width of the upper partition portion 241 in the second direction and the width of the lower partition portion 242 in the second direction.

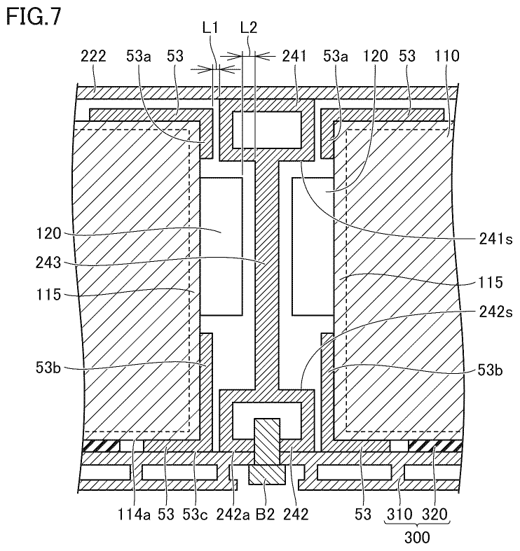

As shown in FIGS. 5 and 7, the upper partition portion 241 has an upper facing portion 241s facing the external terminal 120 in the upward-downward direction. The lower partition portion 242 has a lower facing portion 242s facing the external terminal 120 in the upward-downward direction. That is, the upper partition portion 241 and the lower partition portion 242 overlap the external terminal 120 in the upward-downward direction.

As illustrated in FIG. 7, the restraint band 53 includes an upper interposed portion 53a and a lower interposed portion 53b.

The upper interposed portion 53a is interposed between each of the power storage stacks 11 to 14 and the upper partition portion 241. The lower interposed portion 53b is interposed between each of the power storage stacks 11 to 14 and the lower partition portion 242. The lower surface 53c of the lower interposed portion 53b may be formed to be flush with the lower surface 242a of the lower partition portion 242.

As illustrated in FIG. 7, a distance L1 between the upper interposed portion 53a and the upper partition portion 241 is smaller than a distance L2 between the external terminal 120 and the connecting portion 243. Similarly, the distance between the lower interposed portion 53b and the lower partition portion 242 is smaller than the distance L2. The distance between the lower interposed portion 53b and the lower partition portion 242 may be the same as the distance L1 between the upper interposed portion 53a and the upper partition portion 241.

The support member 300 supports the lower surfaces 114a of the end portions of the pair of power storage cells 100 adjacent to each other in the second direction. The support member 300 is connected to the lower partition portion 242 of the partition wall 240. As shown in FIG. 5, the power storage device 10 according to the present embodiment includes five support members 300 spaced apart from each other in the second direction. Each support member 300 includes a support member main body 310 and an adhesive member 320.

The support member main body 310 is disposed at a position overlapping each end portion of the pair of power storage cells 100 facing each other in the second direction in the upward-downward direction. The support member main body 310 has a shape in which a portion (a portion including the safety valve SV) of the lower surface 114a of the cell case 114 other than a portion overlapping the support member main body 310 in the upward-downward direction is exposed downward. In other words, a portion of the lower surface 114a of the cell case 114 that does not overlap the support member main body 310 in the upward-downward direction is exposed downward. The support member main body 310 extends in the first direction. The support member main body 310 may be formed by extrusion of a metal such as aluminum.

Each of the three support member main bodies 310 disposed at the center in the second direction is fastened to the lower end portion of the lower partition portion 242 by a bolt B2. Each of the pair of support member main bodies 310 disposed on the outer side in the second direction is fastened to the lower portion of the side wall 212 by a bolt B2. As shown in FIGS. 4 and 5, a notch 212s for receiving the support member main body 310 is formed in a lower portion of each side wall 212.

The support member main body 310 has a lower surface 310a formed to be flush with the lower surface 212a of each side wall 212. The lower surface 310a of the support member main body 310 is connected to the bottom wall 230 by an adhesive member 350. In FIG. 6, an imaginary plane L including the lower surface 212a of the side wall 212 and the lower surface 310a of the support member main body 310 is indicated by a two-dot chain line.

The adhesive member 320 adheres the end portion of the support member main body 310 in the second direction to the lower surface 114a of the power storage cell 100.

As shown in FIG. 4, the pair of support members 300 adjacent to each other in the second direction are in contact with the bottom wall 230 and the lower surface 114a of the end portion of the power storage cell 100 in the second direction. The pair of support members 300 define a space S below each of the power storage stacks 11 to 14 together with the power storage cell 100 and the bottom wall 230. That is, in the present embodiment, four spaces S are formed in the housing 200.

As shown in FIG. 3, each space S extends in the first direction. Each space S functions as a smoke discharge path (Hereinafter, it is referred to as a “smoke discharge path S”.). The smoke discharge path S is a path for discharging the gas discharged from the safety valve SV of the power storage cell 100 to the outside of the housing 200. Each of the smoke discharge paths S is connected to a common space in the housing 200 at an end of the smoke discharge path S in the first direction.

As shown in FIG. 3, an explosion-proof valve 290 is provided at a portion of the connecting wall 214 facing the smoke discharge path S in the first direction. The explosion-proof valve 290 is provided in the common space in the housing 200. The explosion-proof valve 290 releases the pressure in the housing 200. The explosion-proof valve 290 opens when the pressure in the housing 200 becomes equal to or higher than a reference value. The explosion-proof valve 290 is constituted by a check valve. As shown in FIG. 3, when a gas is discharged from any of the power storage cells 100, the gas spreads in the first direction through the smoke discharge path S and is discharged to the outside of the housing 200 through the explosion-proof valve 290.

The cooler 500 cools at least one power storage cell 100. A cooling medium (water or the like) flows in the cooler 500. As shown in FIGS. 2 to 4, the cooler 500 is provided on the top wall 220. More specifically, the cooler 500 is disposed in the recess 224 of the top wall 220.

The cooler 500 is in thermal contact with the at least one power storage cell 100 via the top wall 220. In the present embodiment, a thermally conductive adhesive 910 (see FIG. 4) extending in the first direction is provided between the cooler 500 and the recess 224. That is, in the present embodiment, the cooler 500 is in thermal contact with each of the power storage stacks 11 to 14 via the top wall 220 and the thermally conductive adhesive 910. Note that the thermal contact includes a mode in which the cooler 500 comes into contact with the power storage cell 100 only through the top wall 220, and a mode in which the cooler 500 indirectly comes into contact with the power storage cell 100 through a member having thermal conductivity (an adhesive, a fixing member, or the like).

The cooler 500 forms at least a part of the floor portion 30 (see FIG. 3) of the vehicle cabin. The floor portion 30 of the vehicle cabin may include a floor constituent member (a covering member, a buffer member, a carpet, or the like) disposed on the cooler 500 in addition to the cooler 500. In FIGS. 2, 4, and 5, illustration of the floor constituent members is omitted.

The device unit 800 is disposed, for example, at an end portion in the first direction. In the present embodiment, the device unit 800 is disposed on the rear portion of the top wall 220 in the front-rear direction of the vehicle 1. The device unit 800 includes a junction box 812, an electricity supply unit 814, an electronic control unit 816, a unit cooler 824, and a device cover 830.

The junction box 812 is disposed above the top wall 220. The junction box 812 accommodates relays, fuses, and the like.

As shown in FIG. 3, the cooler 500 has an interposed portion 518 interposed between the top wall 220 and the junction box 812. The junction box 812 is cooled by the interposed portion 518.

The power supply unit 814 is disposed above the junction box 812. The power supply unit 814 is cooled by a unit cooler 824 disposed on the power supply unit 814.

The electronic control unit 816 is disposed above the junction box 812.

The device cover 830 houses the junction box 812, the power supply unit 814, the electronic control unit 816, and the unit cooler 824.

In the power storage device 10 described above, when a gas is discharged downward from the safety valve SV due to a short circuit or the like in any of the power storage cells 100, the gas flows into the smoke discharge path S. The gas flowing into the smoke discharge path S spreads in the first direction and is discharged from the housing 200 through the explosion-proof valve 290 as shown in FIG. 3. For this reason, it is possible to suppress the matter (so-called debris) contained in the gas in the power storage cell 100 from adhering to the external terminal 120 or the like of the power storage cell 100.

Further, in the power storage device 10, since the width of the connecting portion 243 provided between the pair of external terminals 120 is smaller than the width of the upper partition portion 241 and the width of the lower partition portion 242, the power storage stacks 11 to 14 can be disposed close to each other, that is, the volumetric efficiency of the power storage device 10 can be improved.

It will be understood by those skilled in the art that the exemplary embodiments described above are specific examples of the following aspects.

### Aspect 1

A power storage device comprising:
a first power storage stack including a plurality of power storage cells arranged in a first direction;
a second power storage stack facing the first power storage stack in a second direction orthogonal to both the first direction and an upward-downward direction, the second power storage stack including a plurality of power storage cells arranged in the first direction; and
a partition wall separating the first power storage stack and the second power storage stack from each other, wherein
the power storage cells each include:
   a cell main body; and
   an external terminal protruding from the cell main body in the second direction,
the partition wall includes:
   an upper partition portion located at a higher position than the external terminal;
   a lower partition portion located at a lower position than the external terminal; and
   a connecting portion located between a pair of the external terminals adjacent to each other in the second direction, the connecting portion connecting the upper partition portion and the lower partition portion to each other, and
a width of the connecting portion in the second direction is smaller than a width of the upper partition portion in the second direction and a width of the lower partition portion in the second direction.

In this power storage device, since the width of the connecting portion provided between the pair of external terminals is smaller than the width of the upper partition portion and the width of the lower partition portion, the first power storage stack and the second power storage stack can be disposed close to each other, that is, the volumetric efficiency of the power storage device can be improved.

### Aspect 2

The power storage device according to Aspect 1, wherein
the upper partition portion includes an upper facing portion facing the external terminal in the upward-downward direction, and
the lower partition portion includes a lower facing portion facing the external terminal in the upward-downward direction.

In this aspect, the total length of the first power storage stack and the second power storage stack in the second direction is reduced.

### Aspect 3

The power storage device according to Aspect 2, further comprising:
an upper interposed portion interposed between the upper partition portion and each of the first power storage stack and the second power storage stack; and
a lower interposed portion interposed between the lower partition portion and each of the first power storage stack and the second power storage stack, wherein
at least one of a distance between the upper interposed portion and the upper partition portion and a distance between the lower interposed portion and the lower partition portion is smaller than a distance between the external terminal and the connecting portion.

In this aspect, when the first power storage stack and the second power storage stack move toward each other due to vibration or the like, the upper interposed portion and the upper partition portion or the lower interposed portion and the lower partition portion come into contact with each other before the external terminal comes into contact with the connecting portion, and thus damage to the external terminal or occurrence of a short circuit is suppressed.

### Aspect 4

The power storage device according to any of Aspects 1 to 3, further comprising:
a top wall located above the first power storage stack and the second power storage stack;
a bottom wall located below the first power storage stack and the second power storage stack; and
a support member connected to the partition wall and supporting a lower surface of each of the power storage stack and the second power storage stack, wherein
the upper partition portion is connected to the top wall,
the support member is connected to the lower partition portion, and
the bottom wall is connected to the support member.

In this aspect, since the partition wall and the support member are interposed between the top wall and the bottom wall, for example, when a downward load acts on the top wall from above the top wall, the load is received by the bottom wall via the partition wall and the support member. Therefore, the input of the load to the power storage cell and the damage of the power storage cell caused by the input of the load are suppressed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a first power storage stack including a plurality of power storage cells arranged in a first direction;
a second power storage stack facing the first power storage stack in a second direction orthogonal to both the first direction and an upward-downward direction, the second power storage stack including a plurality of power storage cells arranged in the first direction; and
a partition wall separating the first power storage stack and the second power storage stack from each other, wherein
the power storage cells each include:
a cell main body; and
an external terminal protruding from the cell main body in the second direction,
the partition wall includes:
an upper partition portion located at a higher position than the external terminal;
a lower partition portion located at a lower position than the external terminal; and
a connecting portion located between a pair of the external terminals adjacent to each other in the second direction, the connecting portion connecting the upper partition portion and the lower partition portion to each other, and
a width of the connecting portion in the second direction is smaller than a width of the upper partition portion in the second direction and a width of the lower partition portion in the second direction.

2. The power storage device according to claim 1, wherein
the upper partition portion includes an upper facing portion facing the external terminal in the upward-downward direction, and
the lower partition portion includes a lower facing portion facing the external terminal in the upward-downward direction.

3. The power storage device according to claim 2, further comprising:
an upper interposed portion interposed between the upper partition portion and each of the first power storage stack and the second power storage stack; and
a lower interposed portion interposed between the lower partition portion and each of the first power storage stack and the second power storage stack, wherein
at least one of a distance between the upper interposed portion and the upper partition portion and a distance between the lower interposed portion and the lower partition portion is smaller than a distance between the external terminal and the connecting portion.

4. The power storage device according to claim 1, further comprising:
a top wall located above the first power storage stack and the second power storage stack;
a bottom wall located below the first power storage stack and the second power storage stack; and
a support member connected to the partition wall and supporting a lower surface of each of the power storage stack and the second power storage stack, wherein
the upper partition portion is connected to the top wall,
the support member is connected to the lower partition portion, and
the bottom wall is connected to the support member.
